(19) United States
(12) Patent Application Publication
(10) Pub. No.: US 2003/0021451 A1
(43) Pub. Date: Jan. 30, 2003

(54) Method for acquiring fingerprints by linear fingerprint detecting sensor

(75) Inventor: Ki-Deak Lee, Seoul (KR)

Correspondence Address: Jonathan Y. Kang, Esq., Lee & Hong P.C., 11th Floor, 221 N. Figueroa Street, Los Angeles, CA, 90012-2601, US

(73) Assignee: Cecrop Co., Ltd.

(21) Appl. No.: 09/945,009

(22) Filed: Aug. 30, 2001

(30) Foreign Application Priority Data
May 25, 2001 (KR) 2001-28809

(51) Int. Cl. G06K 9/00; G06K 9/34; G06K 9/36

(52) U.S. Cl. 382/124; 382/107; 382/173; 382/284

(57) ABSTRACT

The method for acquiring fingerprint by using a linear fingerprint detecting sensor comprises the steps of: capturing a fingerprint image sequentially through the fingerprint detecting sensor; dividing scanned fingerprint image as a predetermined segments according to a constant time and speed; detecting the optimum overlap region by comparing each image strip and its segment with the next image strip; calculating the value of mean image variation through the overlap region; and mixing the entire image by applying the mean image variation value to each image strip. According to the present invention, the method for acquiring fingerprints by a linear fingerprint detecting sensor in accordance with the present invention can improve the correct recognition rate greatly by estimating and compensating for the scanned image by the fingerprint detecting sensor and accurately restoring the same to the original image.

### BACKGROUND OF THE INVENTION

1. Field of the Invention

The present invention relates to a method for acquiring fingerprints by a linear fingerprint detecting sensor, and more particularly, to a method for acquiring fingerprints by a linear fingerprint detecting sensor by which a fingerprint image captured by the linear sensor is acquired by the estimation and restoration of the fingerprint image.

2. Description of the Related Art

As is generally known, fingerprints have been recently adapted to many fields since the modem fingerprinting method was established by Edward R. Henry. Particularly, fingerprints are widely used as strong personal authentication means in the fields of pay, personnel, banking, criminal investigation, security, etc.

A personal authentication process using fingerprints largely includes a classification procedure for classifying a wide variety of fingerprints by shapes and a matching procedure for identifying a person.

At this time, prior to the classification of fingerprints by shapes, a fingerprint image is captured, and then it is checked whether the fingerprint image is a registered image, for thereby authenticating the fingerprint.

In case of using a linear sensor as a method for recognizing fingerprints in the prior art, a plurality of image strips are captured, and thus a method for combining captured image strips is required.

The U.S. Pat. No. 6,002,815 discloses a method for combining image segments. The image combining method is a method for restoring the full image using a series of image strips acquired by the linear sensor by vertically compensating for the difference of movement speeds of a finger, an object.

However, the image restoration method disclosed in the U.S. Pat. No. 6,002,815 also has a problem that it cannot suggest a method for compensating for a pressure difference for a sensor of a finger and horizontal and rotational directions.

### SUMMARY OF THE INVENTION

It is, therefore, an object of the present invention to provide a method for acquiring fingerprints by a linear fingerprint detecting sensor capable of restoring a precise fingerprint image by dividing a fingerprint image into a plurality of regions, estimating the optimum matching point of each divided region and compensating for the fingerprint image deformed based on the matching point.

In order to achieve the above-described object of the present invention, there is a method for acquiring fingerprint by using a linear fingerprint detecting sensor comprising the steps of: capturing a fingerprint image sequentially through the fingerprint detecting sensor; dividing scanned fingerprint image as a predetermined segments according to a constant time and speed; detecting the optimum overlap region by comparing each image strip and its segment with the next image strip; calculating the value of mean image variation through the overlap region; and mixing the entire image by applying the mean image variation value to each image strip.

Preferably, the captured fingerprint image is divided a plurality of segments in which the width of each segments is the same as the height of each image strip.

Preferably, the step of calculating the image variation value further comprises the steps of: comparing a single image strip with the next image strip; and estimating a vertical movement value of the fingerprint image.

Preferably, the step of calculating the image variation value further comprises the steps of: comparing a segment of a single image strip with a segment of the next image strip; and estimating a horizontal variation value by using an overlap region.

Preferably, the overlap rate of each image strip is above 50% because each parameter has a limitation value as follows;

$${[ Δ x ]}_{o p t} \approx \frac{N}{2 N} , {[ Δ y ]}_{opt} \approx \frac{M}{2} , {[ Δ a ]}_{op t} \approx \frac{M}{2 N} .$$

Preferably, in the step of capturing the fingerprint image, the capturing rate according to the speed of movement of fingerprint is controlled by using the following speed change formula applied the limitation value of each parameter, where the formula,

$${V}_{j + 1} = max ( \frac{2 {v}_{j} Δ {y}_{j}}{M} , \frac{2 M {v}_{j} Δ {x}_{j}}{N} , \frac{2 M {v}_{j} Δ {a}_{j}}{N} ) .$$

Preferably, a degree of inclination to the image variation is calculated by using the following formula under the superposed fingerprint image, where the formula,

$$tan ( Δ a ) = \frac{M * tan ( {a}_{y} )}{N + M * tan ( {a}_{x} )} .$$

Preferably, the step of mixing the entire image further comprises the steps of: summing the variation value of local coordinates (horizontal, vertical, degree of inclination) from the referenced image strip through the following formulas; and estimating a global coordinate, where the formulas,

Aᵢ₊₁=Aᵢ+Δa

Xᵢ₊₁=Xᵢ+Δx cos(Aᵢ₊₁)−Δy sin(Aᵢ₊₁)

Y_{i+i=Yi+Δx} sin(Aᵢ₊₁)−Δy cos(Aᵢ₊₁).

### BRIEF DESCRIPTION OF THE DRAWINGS

The above objects, features and advantages of the present invention will become more apparent from the following detailed description when taken in conjunction with the accompanying drawings, in which:

FIG. 1 is a flow chart schematically illustrating a method for acquiring fingerprints by a linear detecting sensor in accordance with a first embodiment of the present invention;

FIG. 2 is a flow chart illustrating a method for constituting an acquired fingerprint image by a linear fingerprint detecting sensor in accordance with the first embodiment of the present invention;

FIG. 3 is a view illustrating a sensing region sensed by the linear detecting sensor in accordance with the present invention;

FIG. 4 is a view illustrating a variable value of an image strip;

FIG. 5 is a view illustrating a sensing region divided into particular strips;

FIGS. 6a and 6b are views illustrating a degree of inclination according to the movement of an image strip;

FIG. 7 is a view illustrating a resultant value according to an approximate function according to FIGS. 6a and 6b;

FIGS. 8a through 8e are views illustrating types of fingerprint variable values;

FIGS. 9a through 9e are views illustrating a sensed state according to the types of fingerprint variable values;

FIGS. 10, 11a and 11b are state diagrams illustrating an image restoration state by a fingerprint recognition system in accordance with the present invention.

### DETAILED DESCRIPTION OF THE PREFERRED EMBODIMENT

A preferred embodiment of the present invention will now be described with reference to the accompanying drawings.

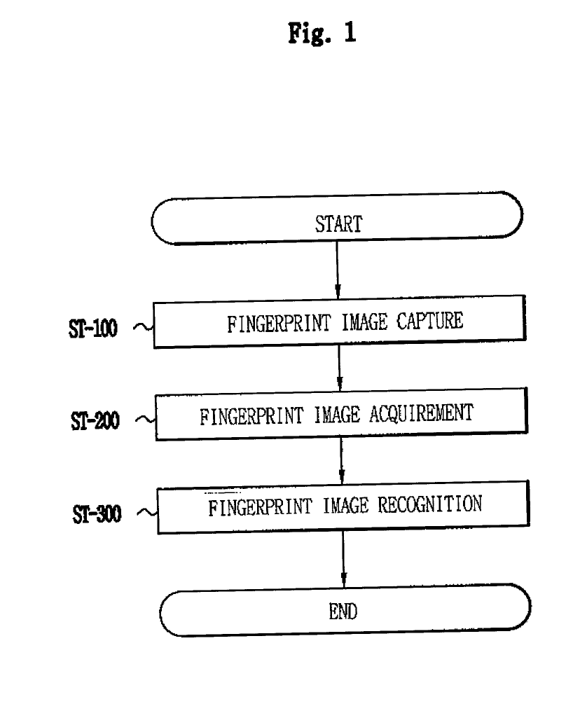

FIG. 1 is a flow chart schematically illustrating a method for acquiring fingerprints by a linear detecting sensor in accordance with a first embodiment of the present invention.

Hereinafter, the method for acquiring fingerprints by a linear fingerprint detecting sensor in accordance with the present invention will now be described in detail with reference to the accompanying drawings.

FIG. 2 is a flow chart illustrating a method for constituting an acquired fingerprint image by a linear fingerprint detecting sensor in accordance with the first embodiment of the present invention.

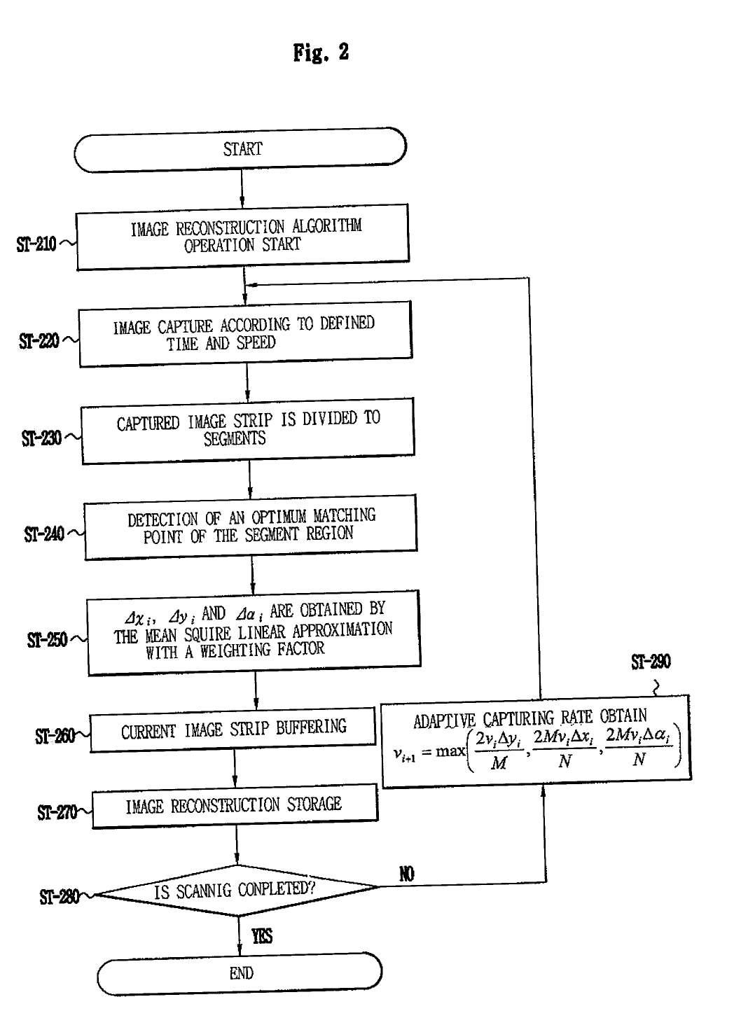

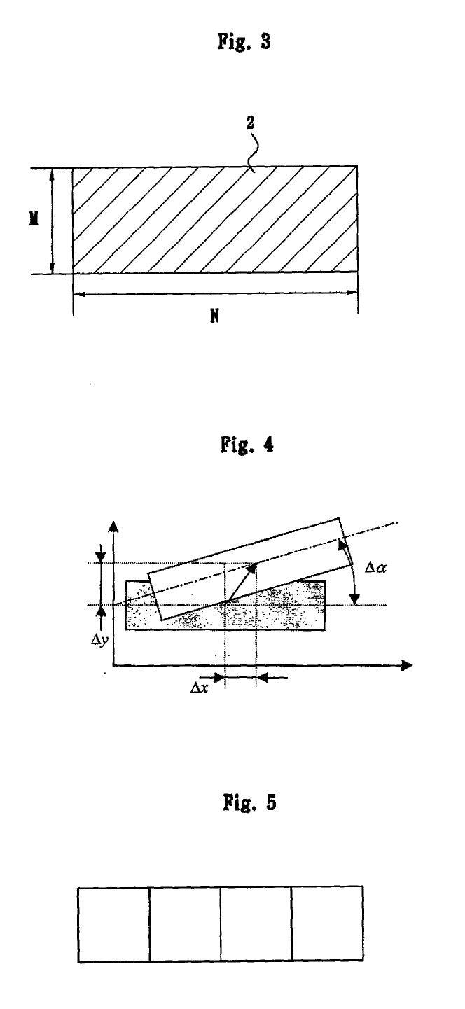

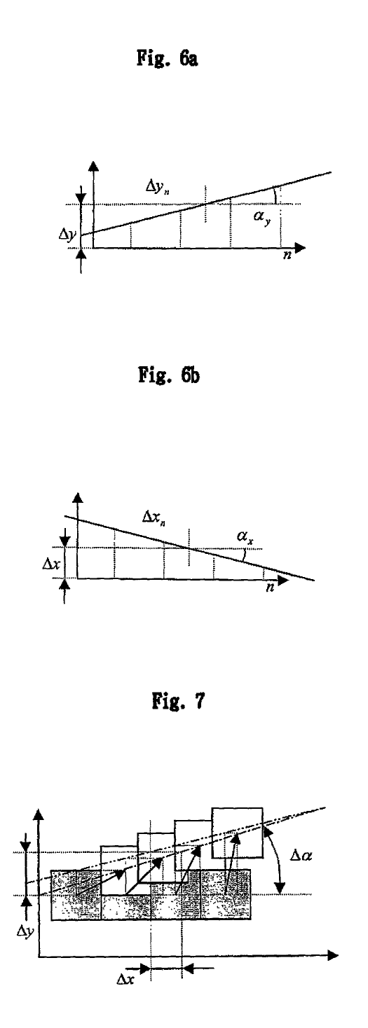

FIG. 3 is a view illustrating a sensing region sensed by the linear detecting sensor in accordance with the present invention. FIG. 4 is a view illustrating a variable value of an image strip. FIG. 5 is a view illustrating a sensing region divided into particular strips. FIGS. 6a and 6b are views illustrating a degree of inclination according to the movement of an image strip. FIG. 7 is a view illustrating a resultant value according to an approximate function according to FIGS. 6a and 6b.

Firstly, the fingerprint detecting sensor generates continuous image strips, and estimates a variable value between the strips by using an overlap region between two sequential strips. Each strip has at least two rows consisting of discrete points and pixels. With the image strips acquired by the sensor, the distance between the strips is estimated and the image strips are combined to produce a composite image.

As soon as the user contacts his or her finger to the fingerprint detecting sensor, scanning and image restoration are initiated in ST-210.

At this time, the fingerprint detecting sensor scans a fingerprint image according to a constant time and speed in ST-220.

More specifically, assuming that the movement direction of the finger, which is an object moving on the upper surface of the fingerprint detecting sensor, and the pressure applied on the fingerprint detecting sensor by the finger are different from each other, a produced image is affected by the movement characteristic of the finger.

Therefore, in the method for acquiring fingerprints of the present invention, sequentially acquired image strips are captured so that they can be combined, and a set of coordinate variables (x, y coordinates) for each image is generated.

In the present invention, when each image segment is combined to be generated as the full image, the coordinate set provides the accurate position of the corresponding image strip. In addition, in the method for acquiring fingerprints of the present invention, added information about the combination of fingerprint images, such as the start and end position of an image, the loss state of synchronization, etc. are acquired and the adaptive capturing rate is calculated and produced by the movement amount of each image strip.

For this purpose, in the method for acquiring fingerprints according to the present invention, (x,y,a) is used for the local coordinate system between two adjacent strips of a captured fingerprint image, and (X,Y,Z) is used for the global coordinate system for the fall image. The coordinate difference of the local coordinate system is represented as (Δx, Δy, Δa).

At this time, a sensor region consists of N columns and M rows as illustrated in FIG. 3. Since the sensor is a linear sensor, it is assumed that N≧M². The image strips acquired by this sensor has the same size as the sensor region.

That is, the method for acquiring an image by the combination of images according to the present invention includes a series of processes for acquiring image strips. In order to estimate the movement amount of an image according to a movement value of the relative coordinate, as illustrated in FIG. 4, the central movement amount of the image strips and the rotational movement value thereof are calculated by comparison of the image strips.

At this time, in order to compare a plurality of image strips, it is necessary that an overlap region where the image strips are overlapped is present. Thus, the capturing rate of the fingerprint detecting sensor is controlled according to the speed change of the finger so that the image strips are overlapped with one another.

Strips Sj and Sj+1 are captured at speed Vⱼ at time tⱼ and tⱼ₊₁ in ST-230.

That is, as illustrated in FIG. 5, the image strip is divided into M segments which is the same as the height (for example, M) of each image strip in order to detect the horizontal variable value of the image strip.

Then, based on the segment of the first image strip S1 of all the image strips, the optimum overlap region in the segment region of the next image strip S2 is detected in ST-240.

In addition, a degree of vertical/horizontal deformation is estimated by the angle of rotation or deformation between the first image strip S1 and the next image strip S2, and simultaneously the mean weight value is given to each variable value, for thereby combining the image strips. That is, Δxⱼᵢ and Δyⱼᵢ are calculated based on the optimum matching point, and Δxⱼ, Δyⱼ and Δaⱼ of Sⱼ₊₁ are obtained by the mean squire linear approximation with a weighting factor in ST-250.

In other words, as illustrated in FIG. 5, the image is captured so that a plurality of image strips having M segments can be formed, the overlap region of the image strips is adapted to calculate a vertical displacement value, and the segments divided from each image strip are compared to calculate a horizontal displacement value.

By this, as illustrated in FIGS. 6a and 6b, the overlap regions of the image strips forms an approximate value in the global coordinate system. Local(x,y) movement values Δxₙ and Δyₙ indicate the position of the minimum value of the differential function of the corresponding segment. The mean squire linear approximation with a weighting value is used to estimate sloping side Δa, tangential displacement Δy and parallel displacement Δx.

At this time, as illustrated in FIGS. 6a and 6b, isometric approximation is adapted to acquire a degree of inclination of Δxₙ=Δx(n) and Δyₙ=Δy(n) and Δx and Δy. The displacement of Δx and Δy is acquired by the approximate function value at the center of the first image strip.

Therefore, when the overlap region is estimated from the image strip divided into a plurality of segments which is captured as the finger moves, as illustrated in FIG. 7, the image displacement is represented which is the same as the displacement of each segment with a constant sloping side.

The degree of inclination for the image displacement of the segment will be expressed by mathematical formula 1.

$$tan ( Δ a ) = \frac{M * tan ( {a}_{y} )}{N + M * tan ( {a}_{x} )} \qquad [ Mathematical Formula 1 ]$$

When Y(n)=y(n) in FIG. 6a and

$$X ( n ) = \frac{N}{M} * n + x ( n )$$

in FIG. 6b and the two formulas are differentiated for n, Mathematical Formula 1 can be represented as

$$\frac{ⅆ Y}{ⅆ n} = \frac{ⅆ y}{ⅆ n} = tan ( ⅆ y ) a n d \frac{ⅆ X}{ⅆ n} = \frac{N}{M} + \frac{ⅆ x}{ⅆ n} = \frac{N}{M} + tan ( ⅆ x ) .$$

As illustrated in FIG. 7, three parameters for the movement amount of fingerprints are presented between segments of a plurality of overlapped image strips.

Those parameters includes tangent line, parallel displacement amount and angle of rotation. By using the thusly calculated parameter set in the local coordinate system, the image strips are compared with one another, and then are combined in the global coordinate system, for thereby acquiring a complete image.

That is, strips Si+1(local coordinate) are accumulated in the appropriate position of the full image buffer(global coordinate system) by using Δxⱼ, Δyⱼ and Δaⱼ in ST-260. When the buffering is completed, the corresponding full image is stored in ST-270.

At this time, it is judged whether scanning is completed in ST-280.

If the scanning is not completed, it is necessary to control the capturing rate according to the change of the movement speed of the finger so that certain regions of the image strips are overlapped. To change the capturing rate, at least one of the coordinate parameters has to be spaced as long as a predetermined marginal value.

$${[ Δ x ]}_{o p t} \approx \frac{N}{2 N} , {[ Δ y ]}_{opt} \approx \frac{M}{2} , {[ Δ a ]}_{op t} \approx \frac{M}{2 N} \qquad [ Mathematical Formula 2 ]$$

The marginal value of each parameter described in Mathematical Formula 2 is adapted so that approximately 50% of the image strips can be overlapped with one another. At this time, the capturing rate vᵢ₊₁ of the sensor can be calculated by analogy of Mathematical Formula 2.

That is, assuming that Δyᵢ₊₁ converges to

$$\frac{M}{2} ,$$

when Δvᵢ×Δyᵢ ˜const and Δvᵢ₊₁×Δyᵢ₊₁˜const, the displacement of y of

$$v i + 1 ( v i + 1 = \frac{2 {v}_{i} Δ {y}_{i}}{M} )$$

can be calculated. Likewise, if x and a are calculated in the same manner, the following capturing rate is obtained.

$${V}_{j + 1} = max ( \frac{2 {v}_{j} Δ {y}_{j}}{M} , \frac{2 M {v}_{j} Δ {x}_{j}}{N} , \frac{2 M {v}_{j} Δ {a}_{j}}{N} ) \qquad [ Mathematical Formula 3 ]$$

In the present invention, Mathematical Formula 3 is adapted to the step ST-220 for capturing a fingerprint image for thereby controlling the capturing rate in ST-290.

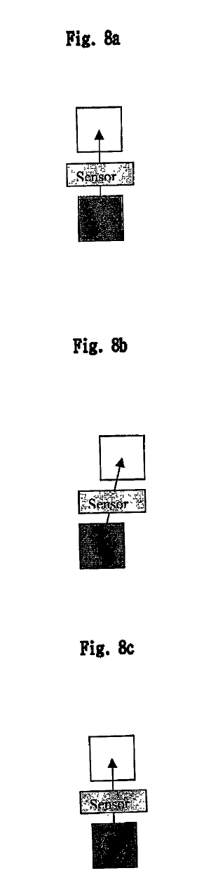

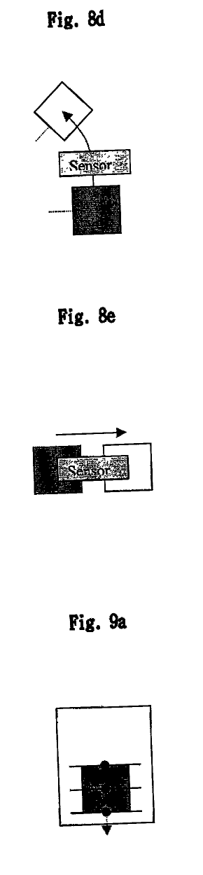

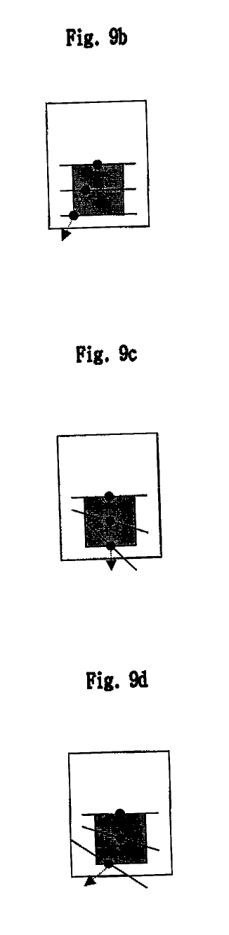

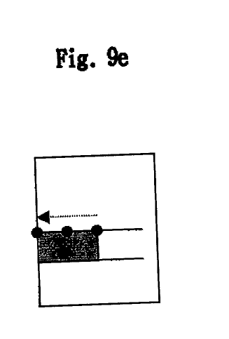

FIGS. 8a through 8e are views illustrating types of fingerprint variable values. FIGS. 9a through 9e are views illustrating a sensed state according to the types of fingerprint variable values.

Referring to this, the fingerprint image shows a variety of types according to a variable value for each movement as illustrated in FIGS. 8a through 8e. The value of the corresponding parameter is different according to each of the types. For example, FIG. 8 illustrates a vertical parallel displacement by which the x coordinate movement and rotation of the finger is not made, x and a indicate 0.

Moreover, FIG. 8b illustrates the case where the movement direction of the sensor and the finger is not orthogonal but has a lateral movement component Δx. FIG. 8c illustrates the combination of vertical movement and rotation. FIG. 8d is similar to FIG. 8c excepting that horizontal movement is made on the image coordinate ΔX by a rotation difference at the central position. In FIG. 8e, it is impossible to produce the composite image since all portions of the finger are deviated from the sensing region.

At this time, since X,Y and A fully define the position of the current image strip on the global image coordinate, the global coordinate(image coordinate) is performed on the local coordinate(coordinate of the sensor) by a recursive procedure such as the following formula.

[Mathematical Formula 4]

Aᵢ₊₁=Aᵢ+Δa

Xᵢ₊₁=Xᵢ+Δx cos(Aᵢ₊₁)−Δy sin(Aᵢ₊₁)

Yᵢ₊₁=Yi+Δx sin(Aᵢ₊₁)−Δy cos(Aᵢ₊₁)

That is, as expressed in Mathematical Formula 4, Aᵢ₊₁, Xᵢ₊₁ and Yᵢ₊₁ can calculate the global coordinate and produce the composite image by summing the parameters Aᵢ, Xᵢ and Yᵢ of the previous image strip and variable values thereof.

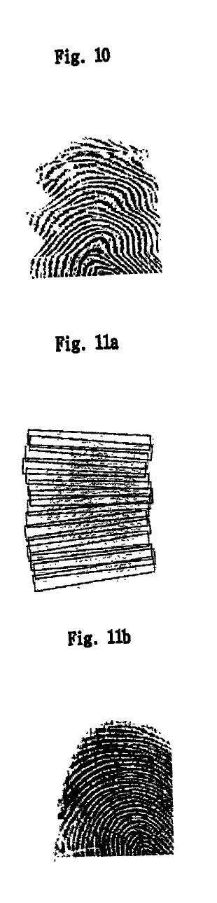

FIGS. 10, 11a and 11b are state diagrams illustrating an image restoration state by a fingerprint recognition system in accordance with the present invention.

Referring to this, FIG. 10 illustrates a view of capturing a fingerprint image deformed in a horizontal or vertical direction by applying a pressure on the fingerprint detecting sensor. The fingerprint recognition system of the present invention restores a scanned fingerprint image by image estimation and restoration algorithm as illustrated in FIG. 8.

At this time, in the present invention, as shown in FIG. 11a, the scanned image is divided into multistage image strips and then the values of the rotation of the image strips and the image deformation are calculated by comparing one image strip with the next image strip based on the overlap region of the image strips. Based on the calculated values, the original image is restored as illustrated in FIG. 11b.

Meanwhile, the method for acquiring fingerprints by a linear fingerprint detecting sensor in accordance with the present invention can be used as a method for identifying a user for access control or prior to the driving of a PC or as means for identifying a user of a mobile phone. That is, this method can be used widely as a method for accurately identifying a user of various personal electronic equipment, and can be adapted to every methods for improving correct recognition rate for fingerprint recognition including criminal investigation.

While the invention has been shown and described with reference to certain preferred embodiments thereof, it will be understood by those skilled in the art that various changes in form and details may be made therein without departing from the spirit and scope of the invention as defined by the appended claims.

As seen from above, the method for acquiring fingerprints by a linear fingerprint detecting sensor in accordance with the present invention can improve the correct recognition rate greatly by estimating and compensating for the scanned image by the fingerprint detecting sensor and accurately restoring the same to the original image.

What is claimed is:

1. A method for acquiring fingerprint by using a linear fingerprint detecting sensor comprising the steps of:
capturing a fingerprint image sequentially through the fingerprint detecting sensor;
dividing scanned fingerprint image as a predetermined segments according to a constant time and speed;
detecting the optimum overlap region by comparing each image strip and its segment with the next image strip;
calculating the value of mean image variation through the overlap region; and
mixing the entire image by applying the mean image variation value to each image strip.

2. The method according to claim 1, wherein the captured fingerprint image is divided a plurality of segments in which the width of each segments is the same as the height of each image strip.

3. The method according to claim 1, wherein the step of calculating the image variation value further comprises the steps of:
comparing a single image strip with the next image strip; and
estimating a vertical movement value of the fingerprint image.

4. The method according to claim 1, wherein the step of calculating the image variation value further comprises the steps of:
comparing a segment of a single image strip with a segment of the next image strip; and
estimating a horizontal variation value by using an overlap region.

5. The method according to claim 1, wherein the overlap rate of each image strip is above 50% because each parameter has a limitation value as follows;
$${[ Δ x ]}_{opt} \approx \frac{N}{2 N} , {[ Δ y ]}_{opt} \approx \frac{M}{2} , {[ Δ a ]}_{opt} \approx \frac{M}{2 N} .$$

6. The method according to claim 1, wherein in the step of capturing the fingerprint image, the capturing rate according to the speed of movement of fingerprint is controlled by using the following speed change formula applied the limitation value of each parameter, where the formula,
$${V}_{j + 1} = max ( \frac{2 {v}_{j} Δ {y}_{j}}{M} , \frac{2 M {v}_{j} Δ {x}_{j}}{N} , \frac{2 M {v}_{j} Δ {a}_{j}}{N} ) .$$

7. The method according to claim 1, wherein a degree of inclination to the image variation is calculated by using the following formula under the overlapped fingerprint image, where the formula,
$$tan ( Δ a ) = \frac{M * tan ( {a}_{y} )}{N + M * tan ( {a}_{x} )} .$$

8. The method according to claim 1, wherein the step of mixing the entire image further comprises the steps of:
summing the variation value of local coordinates (horizontal, vertical, degree of inclination) from the referenced image strip through the following formulas; and
estimating a global coordinate, where the formulas,
Aᵢ₊₁=Aᵢ+Δa
Xᵢ₊₁=Xᵢ+Δx cos(Aᵢ₊₁)−Δy sin(Aᵢ₊₁)
Yᵢ₊₁=Yi+Δx sin(Aᵢ₊₁)−Δy cos(Aᵢ₊₁).

9. The method according to claim 5, wherein in the step of capturing the fingerprint image, the capturing rate according to the speed of movement of fingerprint is controlled by using the following speed change formula applied the limitation value of each parameter, where the formula,
$${V}_{j + 1} = max ( \frac{2 {v}_{j} Δ {y}_{j}}{M} , \frac{2 M {v}_{j} Δ {x}_{j}}{N} , \frac{2 M {v}_{j} Δ {a}_{j}}{N} ) .$$
